(19) United States
(12) Patent Application Publication
(10) Pub. No.: US 2005/0122216 A1
(43) Pub. Date: Jun. 9, 2005

(54) Key for lock

(76) Inventor: William R. Matz, Atlanta, GA (US)

Correspondence Address: Scott P. Zimmerman, P.O. Box 3822, Cary, NC, 27519, US

(21) Appl. No.: 10/730,531

(22) Filed: Dec. 8, 2003

(51) Int. Cl. G08B 1/08

(52) U.S. Cl. 340/539.32; 340/693.5

(57) ABSTRACT

A device is disclosed that promotes finding the device when lost. The device includes means for engaging a lock and means for receiving an activation signal from a remote transmitter. When the activation signal is received, the device also includes means for emitting an output signal that promotes finding the device when lost.

### NOTICE OF COPYRIGHT PROTECTION

A portion of the disclosure of this patent document and its figures contain material subject to copyright protection. The copyright owner has no objection to the facsimile reproduction by anyone of the patent document or the patent disclosure, but the copyright owner otherwise reserves all copyrights whatsoever.

### BACKGROUND OF THE INVENTION

1. Field of the Invention

This invention generally relates to telecommunications and, more particularly, to separate transmitters and receivers for keys and locks.

2. Description of the Related Art

A lost key creates frustration, fear, and anxiety. When a key is lost, time is wasted searching for the key. Nervousness grows the longer the key is lost. If the key is not found, security is compromised, and locks may need to be re-keyed or even replaced.

Because a lost key is a common experience, electronic fobs are common. An electronic fob attaches to a key ring, and the electronic fob includes light and/or sound devices. When the key ring is lost, the electronic fob can be remotely activated to emit lights and/or sounds. These lights and sounds help locate the lost key ring.

Although electronic fobs are known, electronic fobs are not desirable. These fobs can become separated from the key ring, thus defeating the purpose of finding lost keys when activated. Electronic fobs are bulky and reduce the number of keys that may slide on the key ring. Because the electronic fobs are bulky, the fob is uncomfortably carried in a pocket. There is, accordingly, a need for finding lost keys that does not require an electronic fob.

### BRIEF SUMMARY OF THE INVENTION

The aforementioned problems are reduced by a key for a lock. This key, however, includes finding features. These finding features may include audible sources and/or light sources. When the key is lost, the key of this invention responds to wireless signals. When the lost key receives the wireless signals, the finding features are activated. The key thus emits sounds and lights, and a user may more quickly locate the lost key.

One embodiment of this invention describes a device that promotes finding the device when lost. The device includes means for engaging a lock and means for receiving an activation signal from a remote transmitter. When the activation signal is received, the device also includes means for emitting an output signal that promotes finding the device when lost.

Another embodiment of this invention describes a key for a lock. The key has a hollow body comprising a processor controlling receiver circuitry and audible circuitry. The receiver circuitry receives an activation signal from a remote transmitter. The audible circuitry produces an audible indication upon receipt of the activation signal. When the key is lost, the audible indication allows the key to be found.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE SEVERAL VIEWS OF THE DRAWINGS

These and other features, aspects, and advantages of this invention are better understood when the following Detailed Description of the Invention is read with reference to the accompanying drawings, wherein:

FIG. 1 is a schematic showing one of the embodiments of a key for a lock;

FIG. 2 is a sectional view of the key shown in FIG. 1;

FIG. 3 is a block diagram of the key shown in FIGS. 1 and 2; and

FIG. 4 is a schematic illustrating an electronic key, according to yet another of the embodiments of this invention.

### DETAILED DESCRIPTION OF THE INVENTION

This invention now will be described more fully hereinafter with reference to the accompanying drawings, in which exemplary embodiments are shown. This invention may, however, be embodied in many different forms and should not be construed as limited to the embodiments set forth herein; rather, these embodiments are provided so that this disclosure will be thorough and complete, and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, flowcharts, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named manufacturer.

This invention is a key for a lock. This key, however, includes finding features. These finding features may include audible sources and/or light sources. When the key is lost, the key of this invention responds to wireless signals. When the lost key receives the wireless signals, the finding features are activated. The key thus emits sounds and lights, and a user may more quickly locate the lost key.

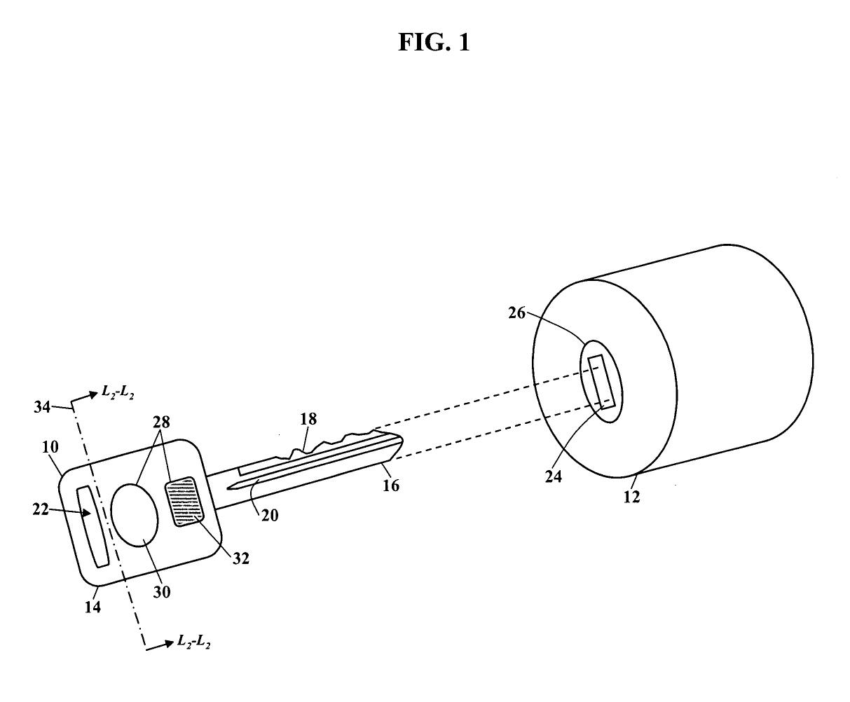

FIG. 1 is a schematic showing one of the embodiments of a key 10 for a lock 12. The key 10 is enlarged for clarity. The key 10 has a head or “bow” 14 and means for engaging the lock 12, such as a blade 16. The blade 16 protrudes from the bow 14 and includes one or more spaced cuts 18. The spaced cuts 18 have various depths and graduations. The blade 16 may also include a groove or “milling” 20 along a length of the blade 16. The bow 14 includes a passage 22 for insertion of a key ring (not shown). As those of ordinary skill in the art understand, a user inserts the blade 16 into a keyway 24 in a cylinder 26 of the lock 12. If the blade 16 engages the lock 12—that is, if the spacing, depth, and graduation of each cut 18 aligns with various pins (not shown) in the keyway 24—then the key 10 can rotate within the cylinder 26 and, thus, lock/unlock the lock 12. Because the inner componentry of the lock 12, the keyway 24, and the cylinder 26 are well-known and not pertinent to this invention, the lock 12 will not be further discussed.

The key 10 of this invention, however, includes electronic componentry. As this patent will explain, if the key 10 is lost, various electronic finding features 28 can be remotely activated. These finding features 28, for example, may include a light 30 and/or a speaker 32. When the key 10 is lost, the electronic componentry can be remotely activated. The light 30 may flash, and the speaker 32 may emit sounds, and these finding features 28 help a user locate the lost key 10.

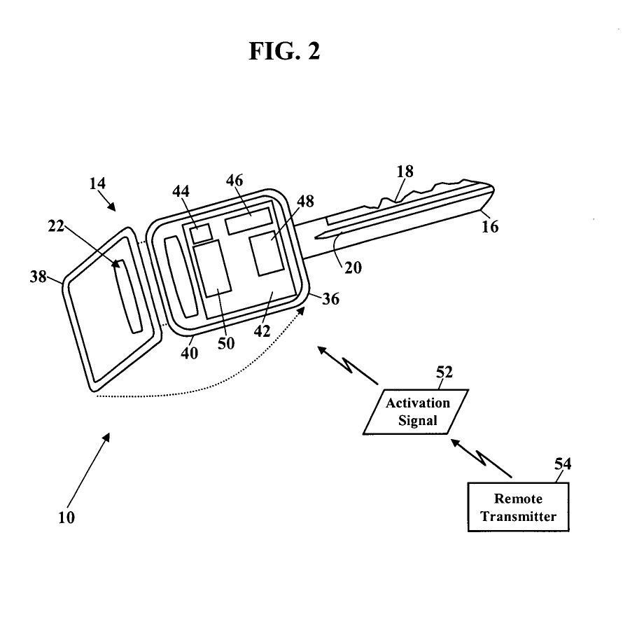

FIG. 2 is a sectional view of the key shown in FIG. 1. This sectional view is taken along line L₂-L₂ of FIG. 1 (shown as reference numeral 34 in FIG. 1). The bow 14 has a hollow body 36. The hollow body 36 has a left-half 38 and a right-half 40. The left-half 38 and the right-half 40 are shown having a clam shell arrangement, although this invention encompasses any arrangement of the halves 38 and 40. Inside the hollow body 36 is means for receiving an activation signal from a remote transmitter, and means for emitting an output signal that promotes finding the device when lost. As FIG. 2 shows, the hollow body 36 houses a circuit board 42. Mounted to the circuit board 42 is a processor 44, receiver circuitry 46, audible circuitry 48, and visual circuitry 50. The processor 44 controls the receiver circuitry 46, the audible circuitry 48, and the visual circuitry 50. When the receiver circuitry 46 receives an activation signal 52 from a remote transmitter 54, the audible circuitry 48 produces an audible indication, such as a beeping sound, chirping sound, or even a ringtone. When the receiver circuitry 46 receives the activation signal 52, the processor 44 commands the audible circuitry 48 and/or the visual circuitry 50 to emit output signals. These output signals manifest themselves as beeps, songs, flashing lights, and other audible/visual emissions. If the key 10 is lost, a user can cause the activation signal 52 to be wirelessly communicated, and the output signals thus allow the user to locate the key 10.

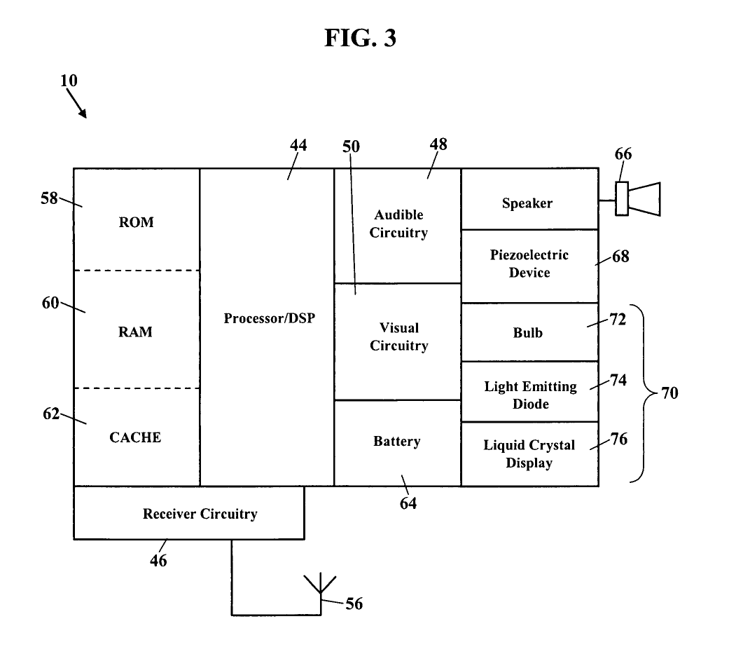

FIG. 3 is a block diagram of the key 10 shown in FIGS. 1 and 2. Here the key 10 comprises the processor 44, the receiver circuitry 46, the audible circuitry 48, and the visual circuitry 50. An antenna 56 couples to the receiver circuitry 46 and converts electromagnetic waves to current. The processor 44 controls the receiver circuitry 46, the audible circuitry 48, and the visual circuitry 50. The processor 44 also performs signal processing functions for electromagnetic signals of any desired frequency within the electromagnetic spectrum. Various memory devices, such as Read-Only Memory (ROM) 58, Random-Access Memory (RAM) 60, and cache memory 62, store instructions and software programming. A battery 64 provides an electrical power source for the processor 44, the receiver circuitry 46, the audible circuitry 48, and the visual circuitry 50. As FIG. 3 shows, the audible circuitry 48 may include a speaker 66 and/or a piezoelectric device 68. When the processor 44 commands, the audible circuitry 48 emits an output signal to help locate the key 10. The output signal produces chirps, beeps, buzzes, ringtones, or any other audible indication/signal. As FIG. 3 also shows, the visual circuitry 50 may include a light source 70. The light source 70 may include a bulb 72, a light-emitting diode (LED) 74, and/or a liquid crystal display (LCD) device 76. When the processor 44 commands, the visual circuitry 50 emits an output signal to help locate the key 10. The output signal produces constant/flashing lights and/or any other visual indication. The output signal may also produce text messages on the liquid crystal display device 76.

The processor 44 may be a digital signal processor (DSP) and/or a microprocessor. Advanced Micro Devices, Inc., for example, manufactures a full line of ATHLON™ microprocessors (ATHLON™ is a trademark of Advanced Micro Devices, Inc., One AMD Place, P.O. Box 3453, Sunnyvale, Calif. 94088-3453, 408.732.2400, 800.538.8450, www.amd.com). The Intel Corporation also manufactures a family of microprocessors (Intel Corporation, 2200 Mission College Blvd., Santa Clara, Calif. 95052-8119, 408.765.8080, www.intel.com). Other manufacturers also offer microprocessors. Such other manufacturers include Motorola, Inc. (1303 East Algonquin Road, P.O. Box A3309 Schaumburg, Ill. 60196, www.Motorola.com), International Business Machines Corp. (New Orchard Road, Armonk, N.Y. 10504, (914) 499-1900, www.ibm.com), and Transmeta Corp. (3940 Freedom Circle, Santa Clara, Calif. 95054, www.transmeta.com). Texas Instruments offers a wide variety of digital signal processors Texas Instruments, Incorporated, P.O. Box 660199, Dallas, Tex. 75266-0199, Phone: 972-995-2011, www.ti.com) as well as Motorola (Motorola, Incorporated, 1303 E. Algonquin Road, Schaumburg, Ill. 60196, Phone 847-576-5000, www.motorola.com). Those of ordinary skill in the art understand that this invention is not limited to any particular manufacturer's processor.

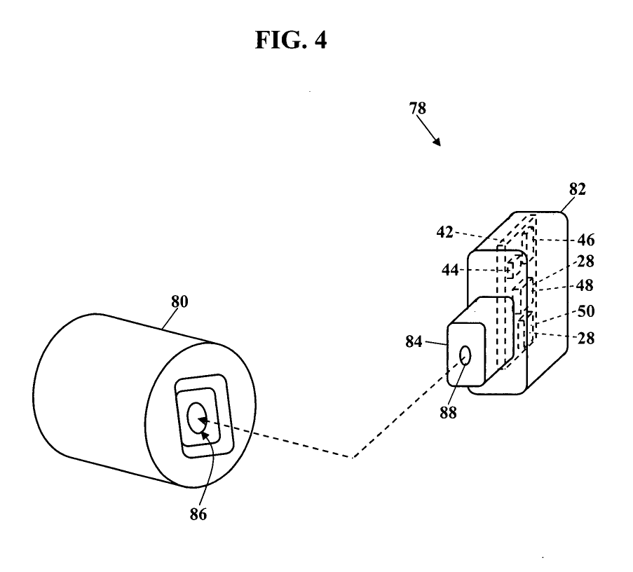

FIG. 4 is a schematic illustrating yet another of the embodiments of this invention. FIG. 4 shows an electronic key 78. This electronic key 78 engages an electronic and/or electromechanical lock 80. The electronic key 78 has a hollow body 82. Inside the hollow body 82 is the means for receiving the activation signal. As FIG. 4 shows, the hollow body 82 houses the circuit board 42. Mounted to the circuit board 42 is the processor 44, the receiver circuitry 46, the audible circuitry 48, and the visual circuitry 50. When the receiver circuitry 46 receives the activation signal (shown as reference numeral 52 in FIG. 2), the processor 44 commands the audible circuitry 48 and/or the visual circuitry 50 to emit output signals. These output signals include beeps, songs, flashing lights, and other audible/visual emissions. If the key 78 is lost, a user can cause the activation signal to be wirelessly communicated, and the output signals thus allow the user to locate the key 78.

The key 78, however, is electronic. That is, the key 78 does not require the blade (shown as reference numeral 16 in FIGS. 1 and 2). Here the means for engaging the lock 80 includes a male portion 84 protruding from the body 82. The male portion 84 inserts into a female portion 86 of the lock 80. The male portion 84 includes an optical and/or electrical terminal 88. The processor 44 communicates with the optical and/or electrical terminal 88 and thus communicates electrical signals from the key 78 to the lock 80 via the optical and/or electrical terminal 88. If the electrical signals are correctly formatted/encoded, the lock 80 responds. The electronic key 78 is especially useful for electronic locks and vehicular ignition systems.

While the present invention has been described with respect to various features, aspects, and embodiments, those skilled and unskilled in the art will recognize the invention is not so limited. Other variations, modifications, and alternative embodiments may be made without departing from the spirit and scope of the present invention.

1. A device, comprising:
means for engaging a lock;
means for receiving an activation signal from a remote transmitter; and
in response to the activation signal, means for emitting an output signal that promotes finding the device when lost.

2. A device according to claim 1, wherein the means for emitting the output signal comprises a light source.

3. A device according to claim 1, wherein the means for emitting the output signal comprises a speaker.

4. A device according to claim 1, wherein the means for emitting the output signal comprises a light-emitting diode.

5. A device according to claim 1, wherein the means for emitting the output signal comprises a liquid crystal display.

6. A device according to claim 1, wherein the means for emitting the output signal comprises a piezoelectric device.

7. A device according to claim 1, wherein the means for engaging the lock comprises a blade for insertion into a keyway of the lock.

8. A key according to claim 1, wherein the means for engaging the lock comprises a male portion for insertion into a female portion of the lock.

9. A key for a lock, comprising:
a hollow body comprising a processor controlling receiver circuitry and audible circuitry;
the receiver circuitry receiving an activation signal from a remote transmitter; and
the audible circuitry producing an audible indication upon receipt of the activation signal,
wherein when the key is lost, the audible indication allows the key to be found.

10. A key according to claim 9, further comprising visual circuitry controlled by the processor, the visual circuitry producing a visible indication upon receipt of the activation signal, the visual indication also allowing the key to be found when lost.

11. A key according to claim 9, further comprising a blade protruding from the body, the blade for insertion into a keyway of the lock.

12. A key according to claim 9, further comprising a male portion protruding from the body, the male portion for insertion into a female portion of the lock.
